(19) United States
(12) Patent Application Publication
(10) Pub. No.: US 2011/0044419 A1
(43) Pub. Date: Feb. 24, 2011

(54) ENERGY GENERATION BY NUCLEAR ACOUSTIC RESONANCE

(76) Inventor: James H. Cook, Simi Valley, CA (US)

Correspondence Address: Cislo & Thomas LLP, 1333 2nd Street, Suite #500, Santa Monica, CA, 90401-4110, US

(21) Appl. No.: 12/544,105

(22) Filed: Aug. 19, 2009

(51) Int. Cl. G21B 1/05; G21B 3/00

(52) U.S. Cl. 376/121; 976/DIG. 1

(57) ABSTRACT

The present invention solves the problems of reliably initiating a low energy fusion reaction by loading deuterium into palladium metal via the process of electrolysis and by initiating the fusion reaction via the application of nuclear acoustic resonance. Affixed on each side of an electrolysis cell are piezoelectric transducers driven by corresponding frequency synthesizers. Surrounding the cell is a magnetic field produced by a magnetic field generator. The application of nuclear acoustic resonance, i.e. the combined application of an alternating magnetic field and of high frequency acoustic waves causes the deuterium atoms resident in the closely packed palladium metallic lattice to fuse into helium atoms with the consequent release of energy that is inherent to the fusion process.

### BACKGROUND OF THE INVENTION

1. Technical Field

The present invention relates generally to methods of energy production via low energy nuclear fusion, and in particular to an improved electrolytic process whereby low energy fusion reactions are initiated via nuclear acoustic resonance.

2. Background Art

The use of fossil fuels such as petroleum, natural gas and coal as sources of energy comes at a substantial price to society. The use of these fuels leads to air and water pollution which threaten the health of the populace and other living things within the environment. The use of fossil fuels also leads to the production of greenhouse gases which are believed by a majority of scientists to cause global warming. Fossil fuels also have other drawbacks apart from environmental issues. In particular, fossil fuels are of finite supply, are subject to rising prices as populations increase, and in the case of oil, the largest reserves of the fuel are located in politically unstable countries. Clean energy sources have their own problems. Wind and hydropower are limited or unreliable sources of energy. Conversion of solar energy to electricity or steam is expensive and not presently cost competitive with fossil fuels. Nuclear fission power, while potentially a large scale replacement for fossil fuels is burdened with substantial issues regarding safety, the disposal of highly toxic spent fuel, and the NIMBY (not in my backyard) syndrome where even that minority of the public that supports fission power plant construction is nevertheless strongly adverse to any such construction in their own community.

Fusion power by contrast is widely recognized as offering a nearly limitless and inexhaustible future source of energy. In view of ever increasing world energy demands, steady depletion of fossil fuels, and the safety and spent fuel disposal issues of nuclear fission based energy production, nuclear fusion energy appears to be the energy source of the future. Although nuclear fusion is near universally recognized as an advantageous energy source, creating a controllable fusion reaction has proven to be an arduous and seemingly unattainable task.

In a hot fusion reaction, deuterium and/or tritium must be heated to high temperatures in order to convert the gas to plasma wherein electrically charged electrons are separated from positively charged deuterium and/or tritium nuclei. However, due to the inherent repulsive forces between the positively charged nuclei, the plasma must then be superheated to extreme temperatures to increase the kinetic energy of the nuclei and thus create high-speed collisions between the nuclei sufficient to overcome the repulsive forces therebetween and permit fusion of the nuclei. Fusion of the nuclei results in the release of energy. This “hot” fusion process is well documented and has been amply demonstrated over the years.

The goal of fusion research for power generation is to produce enough fusion reactions within a magnetic containment field to achieve ignition, i.e. a fusion reaction whereby the reaction is sustained and controlled by the continuous addition of fusion fuel (i.e. deuterium and/or tritium). Unfortunately, current devices used to create a controlled self-sustaining fusion reaction consume more power in heating the plasma to fusion inducing temperatures and in maintaining the containment field than is produced by the fusion reaction itself. Moreover, to date, no containment field has proven sufficiently strong to contain a fusion reaction for more than about one second. Even if a containable, self-sustaining fusion reaction that generated a surplus of energy were to be achieved in the laboratory in the near future, substantial practical problems would remain in how to capture the heat energy released for the purpose of generating electricity. At this time, the construction of a commercial “hot” fusion reactor for the generation of electricity remains decades away.

Given the seemingly insurmountable problems of containing and controlling a hot fusion reaction while at the same time producing a surplus of energy, and the concomitant problems of how to harness the heat energy produced by such a reaction were it to be achieved, some researchers began to take an interest in attempting to achieve a fusion reaction via low energy processes in the solid state. In particular, University of Utah researchers Martin Fleischman and Stanly Pons hypothesized that the high compression ratio and mobility of deuterium that could be achieved within palladium metal using electrolysis might result in nuclear fusion. To investigate their hypothesis, Fleischman and Pons constructed an electrolysis cell using palladium as the cathode and deuterium (in heavy water form) containing an electrolyte. Current was applied to the cell for many weeks with the heavy water being replenished at intervals.

In March of 1989, Fleischman and Pons claimed to have achieved a low energy fusion reaction via the aforementioned process. More specifically, Fleischman and Pons claimed that their electrolysis cell produced significant latent heat, i.e. heat in excess of the energy put into the cell. In the years thereafter, many researchers attempted to duplicate Fleischman and Pons' results. A few also reported the generation of latent heat, while most did not. Of those that did report latent heat, none reported the generation of neutron radiation in amounts sufficient to correlate with the latent heat in accordance with accepted theories of high temperature fusion. None of those who reported success, including Fleischman and Pons, were able to reliably duplicate their initial results.

Problems with the attempts to achieve low energy nuclear fusion revolve around the inability to reproducibly initiate the process. Reproducible initiation has been hampered because, to date, the conditions under which a low energy fusion reaction can reliably be initiated have not yet been established. Low energy fusion development has also been hampered because in those experiments where latent heat has been reported, the amount of heat produced has been far too small to support commercial power generation. It is the purpose of the present invention to provide a mechanism that reliably initiates low energy fusion reactions at controllable rates when added to various devices which would otherwise only produce small amounts of heat by low energy nuclear reactions.

### SUMMARY OF THE INVENTION

The present invention solves the problems of reliably initiating a low energy fusion reaction by providing an electrolysis cell for the creation of energy from hydrogen atoms (also referred to as a low energy fusion reactor) wherein the cell comprises a reaction vessel, a cathode of palladium and/or alloys of palladium and an anode of conductive material, usually platinum. The cathode and anode are submerged in a heavy water (D₂O) solution made electrolytic by the addition of conductive salts such as LiOD, Li₂SO₄, D₂SO₄, K₂CO₃ or the like to promote the conduction of electricity. The cathode and anode are connected in electrical circuit with a power supply capable of supplying direct current (“DC”) power. Affixed on each side of the electrolysis cell are piezoelectric transducers driven by a corresponding frequency synthesizers. Surrounding the cell is a magnetic field generator which may be a solenoid or other device suitable for creating a controllable alternating magnetic field.

Optionally, instrumentation may also provided to monitor magnetic field strength, electrical current input characteristics to the electrolytic cell, acoustic wave frequencies and characteristics as well as to monitor the cell's heat output and nuclear radiation. The present invention operates upon the theory that low energy reactions can be reliably initiated in the electrolysis cell via the application of nuclear acoustic resonance.

### BRIEF DESCRIPTION OF THE DRAWINGS

FIG. 1 is a schematic drawing of the low energy electrolytic fusion cell of the present invention.

FIG. 2 is a schematic representation of an improved design for a low energy fusion heater.

FIG. 3 is a schematic representation of a low energy fusion reactor in accordance with the present invention.

### DETAILED DESCRIPTION OF THE PREFERRED EMBODIMENTS

In describing the preferred embodiments of the present invention, specific terminology is employed for the sake of clarity. The invention, however, is not intended to be limited to the specific terminology selected. It is to be understood that each specific element includes all technical equivalents that operate in a similar manner and/or accomplish similar functions.

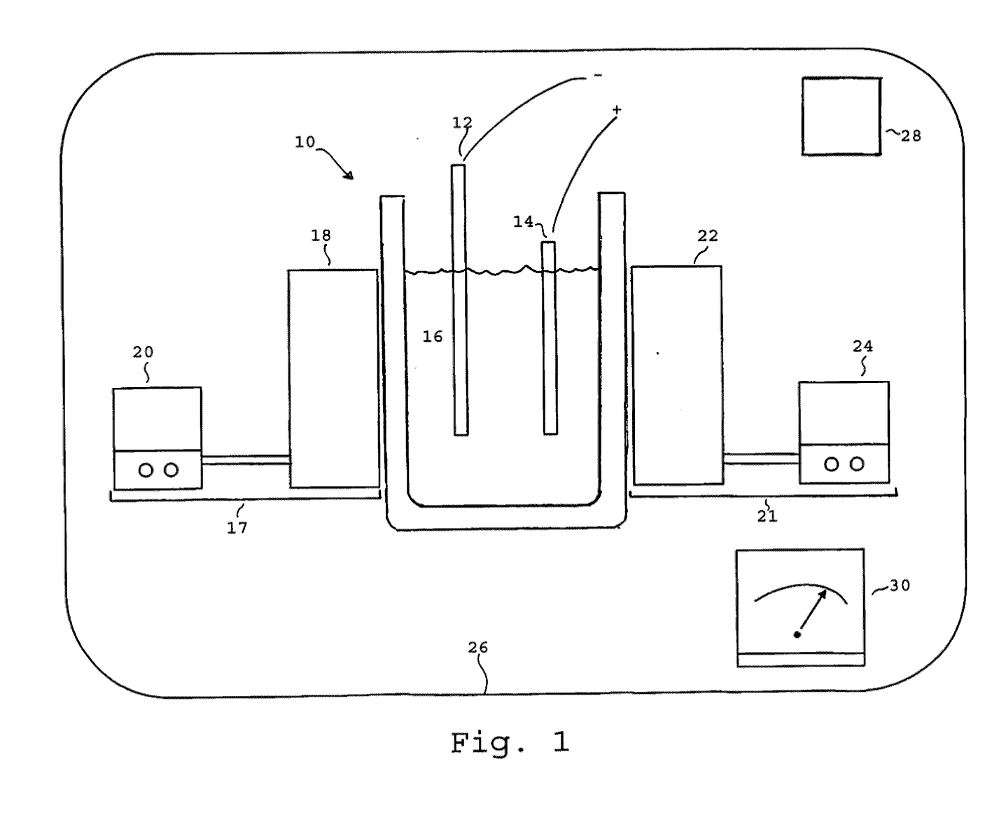

With reference to FIG. 1, the present invention solves the problems of reliably initiating a low energy fusion reaction by providing an electrolysis cell or low energy fusion reactor 10 comprising a reaction vessel such as a Dewar flask 11, a cathode 12, and an anode 14 submerged in an electrolyte or electrolytic solution 16. The cathode is comprised of palladium and/or alloys of palladium. Platinum may be used for the anode, however other materials such as nickel may also be suitable. The electrolytic solution is comprised of a heavy water solution 16, i.e. D₂O or dideuterium oxide, which includes electrolytic salts such as LiOD, Li₂SO₄, D₂SO₄, K₂CO₃ or the like to promote the conduction of electricity. The cathode and anode are connected in electrical circuit with a power supply 28 capable of supplying direct current (“DC”) power in various waveforms. The design and construction of suitable DC power supplies is well known in the art.

Acoustically coupled to the electrolysis cell 10 is at least one acoustic wave generator comprising a piezoelectric transducer which will typically be coupled to a frequency synthesizer. In the embodiment depicted in FIG. 1, a first acoustic wave generator 17 comprising a first piezoelectric transducer 18 driven by a corresponding first frequency synthesizer 20 and a second acoustic wave generator 21 comprising a second piezoelectric transducer 22 driven by a corresponding second frequency synthesizer 24 are shown situated on opposites sides of the reaction vessel 11. Surrounding the electrolytic cell is a magnetic field 25 (not shown) generated by a magnetic field generator (26). A suitable magnetic field generator for use in the present invention is a solenoid such as the one shown in FIG. 1 of R. K. Sundfors, D. I. Bolef, and P. A. Fedders, Nuclear Acoustic Resonance In Metals And Alloys, a review, Hyperfine Interactions, (1983) pp. 271-313, available on the Internet at www.springerlink.com/content/j235371211133767/. Optionally, a gaussmeter 30 may be included for monitoring the strength of the applied magnetic field.

In operation, DC current is passed through the electrolysis cell 10. The current causes the heavy water (D₂O) in the electrolyte solution 16 to decompose into its constituent parts, i.e. 2H and oxygen and the hydrogen atoms are then absorbed (or loaded or packed) into the crystal structure the palladium cathode 12. (The unusual ability of palladium to absorb or load hydrogen atoms was first discovered by Alfred Cohen in 1929 and is well documented.) Although, electrolysis causes the hydrogen atoms to become densely packed within the palladium cathode, electrolysis alone has not proven to be sufficient to reliably cause the nuclei of the hydrogen atoms to become sufficiently closely packed to overcome the Coulomb barrier and initiate a fusion reaction. (Although Fleischman and Pons' argued that electrolysis alone, if applied for a sufficiently long time, would cause the absorbed protons to pack closely enough to overcome the Coulomb barrier, the inability of Fleischman and Pons and other researchers to reliably reproduce their results suggests that other factors in addition to electrolysis are required to initiate a low energy fusion reaction.) Investigators into the facts and circumstances of Fleischman and Pons's original 1989 experiment have noted that the following additional factors likely affected the outcome of the experiment.
1. There was a low-level alternating magnetic field in the vicinity of the experiment caused by a transformer (presumably 60 Hz.) on the opposite side of the wall against which the fume hood containing the experiment was mounted.
2. An unrelated experiment in another part of the room was generating ultrasonic acoustic waves in the Megahertz range. It is believed that two frequencies, differing only slightly from each other, are necessary.
   (See the article, The Truth About DNA, subheading “A past experiment that was incomplete,” published on the Internet at www.kryon.com/k chanelDNA04.html.)

The present invention boosts the electrolysis process by duplicating the conditions present during Fleischman and Pons's original experiment via the application of nuclear acoustic resonance. More specifically, the electrolysis cell 10 is subjected to an alternating magnetic field 25 by the magnetic field generator 26. In addition, the electrolysis cell is bombarded with high frequency acoustic waves via the first and second acoustic wave generators (17, 21), i.e. piezoelectric transducers (18, 22) which are driven by the corresponding first and second frequency synthesizers (20, 24). This application of high frequency acoustic waves causes the hydrogen atoms packed within the crystal lattice of the palladium cathode to undergo spin transitions. Upon reaching the Larmor frequency of the hydrogen atoms and achieving resonance, transitions between spin energy levels are generated. This produces a resonance scan. (See Inventor's Theory of Operation, infra.) It is believed that for reliable initiation of the low energy fusion reaction, the first and second acoustic wave generators (17, 21) must operate at different frequencies. The specific frequencies required remain to be determined by experimentation.

### Application of the New Invention to a Low Energy Fusion Heater

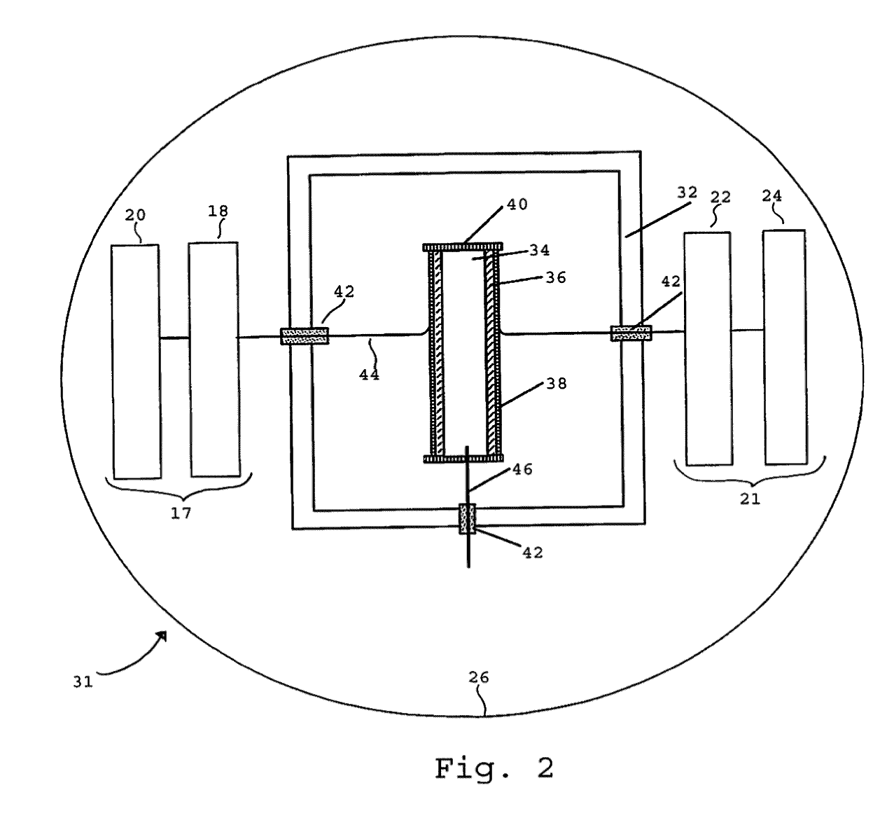

Devices have been conceptualized that would put the heat energy generated by a low energy fusion reaction to practical use. One such device is a low energy fusion heater such as that proposed by Talbot A. Chubb, Ph.D. (See T. A. Chubb, “Cold Fusion, Clean Energy for the Future,” page 48, FIG. 2.10.1, Internet Edition, (April 2008), by New Energy Times, available on the Internet at www.infinite-energy.com.) By applying the principle of nuclear acoustic resonance as taught by the present invention to the heater of Chubb, a working low energy fusion heater is brought a step closer to realization.

Such an improved device is as follows. FIG. 2 depicts in schematic form an improved form of a low energy fusion heater. The device uses a solid electrolyte 36 in contact with metal foils 38 on opposite sides of the electrolyte. One metal foil serves as an anode and the other as a cathode. The device shown in FIG. 2 features two solid electrolyte plates 36 with metal foils 38 on opposite sides and hence contains two electrolytic cells. Both the solid electrolyte and the metal foils are capable of dissolving deuterium, i.e. deuterium may permeate through the foils and electrolyte and when an electric potential is applied across the foils and electrolyte, energy in the form of heat is generated by the low energy fusion reaction which takes place in the reactor plate which is fabricated to contain an oxide-nano-metal composite comprised of calcium oxide-palladium which is sputtered on.

The low energy fusion heater further comprises a pressure tight enclosure 32 and a cylindrical reactor plate 34 for supporting the solid electrolyte. The reactor plate is formed from a material through which deuterium gas may permeate or pass. One such suitable material is a nano-metal composite comprised of metal oxide and palladium layers. (See T. A. Chubb, “Cold Fusion, Clean Energy for the Future,” pages 32-36 (describing ionic nano-metal composites), Internet Edition, (April 2008).) Closing off the reactor plate are end caps 40 which are comprised of an electrically insulative material. The device also includes vacuum-tight pass-throughs 42 which allow wires 44 to pass through the pressure tight enclosure and make contact with the metal foils 38 (the return ground path from the anodes are not shown), as well as a gas input tube 46 for loading deuterium gas into the heater. Deuterium gas which passes through the solid electrolyte cells and the reactor plate collects in the pressure tight enclosure 32. Upon turning off the electrical potential across the solid electrolyte, the deuterium gas in the pressure tight vessel may again diffuse across the solid electrolyte and thus in this manner maybe reused. Alternatively, the gas may be collected and recirculated into the gas input tube 46. The drawback of the above device is that it lacks the ability to reliably initiate a low energy fusion reaction.

The present invention improves on the heater of Chubb by adding the hardware required to create nuclear acoustic resonance conditions within the heater and thereby reliably initiate a low energy fusion reaction as taught by the present invention. As shown in FIG. 2, the Chubb heater has been improved by equipping the device with a first acoustic wave generator 17 comprising a first piezoelectric transducer 18 driven by a corresponding first frequency synthesizer 20 and a second acoustic wave generator 21 comprising a second piezoelectric transducer 22 driven by a corresponding second frequency synthesizer 24. The first and second acoustic wave generators are shown situated on opposites sides of the cold fusion heater 33. Surrounding the pressure tight enclosure 32 is an alternating magnetic field 25 (not shown) generated by a magnetic field generator 26.

Like with the electrolysis cell 10 described above, the low energy fusion heater 31 is subjected to an alternating magnetic field 25 by the magnetic field generator 26. Contemporaneously, the heater is exposed to high frequency acoustic waves via the first and second acoustic wave generators (17, 21). This application of high frequency acoustic waves causes the hydrogen atoms within the crystal lattice of the palladium layer of the reactor plate to undergo spin transitions. Upon reaching the Larmor frequency of the hydrogen atoms and achieving resonance, transitions between spin energy levels are generated. This results in a phenomenon referred to as a resonance scan. (See Inventor's Theory of Operation, infra.)

### A Low Energy Fusion Reactor in Accordance With the Present Invention

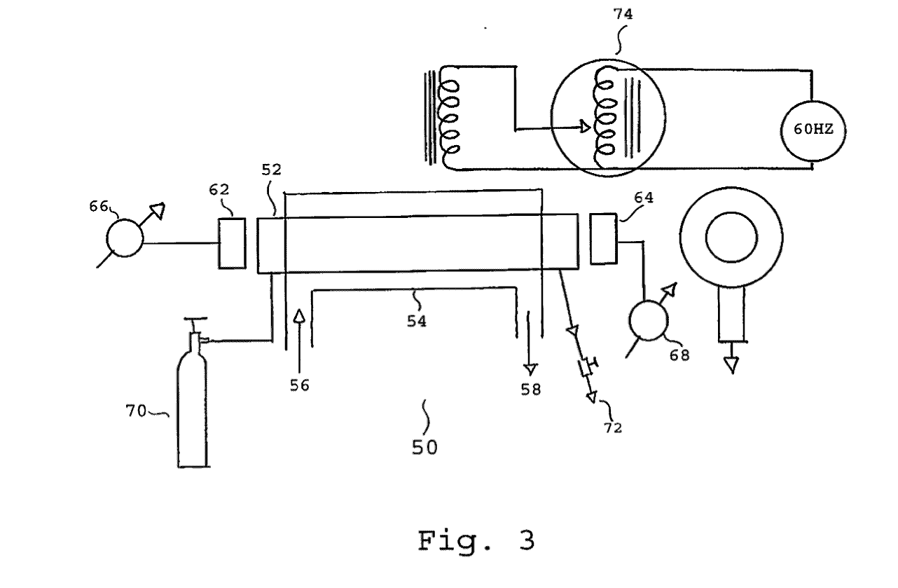

Referring now to FIG. 3, there is shown a low energy fusion reactor 50 in accordance with the present invention. The reactor comprises a reaction chamber 52, a heat exchanger 54 having an inlet 56 and an outlet 58 for the working fluid 60 (not shown) which cools the reaction chamber 52. The reaction chamber is a gas-tight enclosure which may be fabricated from stainless steel and contains an oxide-nano-metal-composite powder which will typically be pressurized with deuterium gas. The working fluid for the heat exchanger may be air or water or a more exotic fluid as is known in the art. At opposite ends of the reaction chamber are first and second ultrasonic transducers 62 and 64, respectively. In electrical connection with the first and second ultrasonic transducers are first and second variable ultrasonic generators 66 and 68, respectively. The ultrasonic transducers may be piezoelectric transducers or other suitable devices as is known in the art.

The low energy fusion reactor 50 further comprises a means for pressurizing the reaction chamber 52 with deuterium gas (such as a gas cylinder) and vent 72 for releasing excess gas from the cylinder. Optionally, a vacuum pump 74 (not shown) may be attached to the vent 72. The reactor further includes a means for subjecting the reaction chamber to a variable alternating magnetic field 74. The means for generating a magnetic field may be a solenoid or other device as is known in the art.

The low energy fusion reactor operates by subjecting the pressurized deuterium gas simultaneously to the effects of an alternating magnetic field and the effects of high energy acoustic waves at two different frequencies. The inventor hypothesizes that when compressed deuterium adsorbs on the nano-metal surface of the oxide-nano-metal powder and is subjected to the above effects, a low energy fusion reaction will be initiated. The inventor's theory regarding the aforementioned process is described below.

### Inventor's Theory of Operation

The present invention is based upon the hypothesis that low energy fusion reactions can be reliably initiated in a reaction vessel containing densely packed deuterium atoms. Traditionally, the reaction vessel has been an electrolysis cell, such as the cell (10) described above where through the process of electrolysis deuterium atoms are closely paced within a crystal lattice. However, a reaction vessel containing oxide-nano-metal composite powder with pressurized deuterium gas may also be suitable. When the reaction vessel is subjected to both an alternating magnetic field and ultrasonic waves. (See the article, The Truth About DNA, subheading “A past experiment that was incomplete,” published on the Internet at www.kryon.com/k chanelDNA04.html.) The combination of an alternating magnetic field and ultrasonic waves is a process called nuclear acoustic resonance. (For a discussion of the phenomenon of nuclear acoustic resonance see B. Strobel, V. Muller, D. Schilling, K. Langer, and H. E. Bommel, Nuclear Acoustic Resonance In Palladium Metal, Letter to the editor, J. Phys. F: Metal Phys., (1979), pp. L247-L250, Vol. 9, No. 12, available on the Internet at www.iop.org/EJ/abstract/0305-4608/9/12/003; see also R. K. Sundfors et al., Nuclear Acoustic Resonance In Metals And Alloys, a review, Hyperfine Interactions, (1983), pp. 271-313.)

Pursuant to the inventor's hypothesis, if the classical picture of point-particle deuterons being inserted in between palladium atoms is taken, then deuterons as well as palladium atoms are separated by about 0.4 nano-meters. This is much larger than nuclear dimensions, and would preclude spin interactions, especially since each pair of deuterons is separated by a palladium atom. A different approach is needed. This is supplied by the theory of the bloch quasiparticle deuteron developed by Chubb and Chubb. (Detailed papers by Talbot A. Chubb and Scott R. Chubb may be found in the library at www.lenr-canr.org.) The deuteron wave function spreads out in a periodic metallic lattice in a manner analogous to the behavior of electrons in a metallic conductor. This permits the deuteron wave functions to touch each other, so that spin interactions can set up the conditions for fusion set forth with this theory. It also provides a mechanism for communicating energy to the lattice. There is one caveat, the lattice must be strictly periodic. When deuterons are first forced into the palladium lattice, they distort it, breaking the symmetry. It is only restored as the palladium approaches full loading (one deuteron per palladium atom). Greater than 85% loading is apparently sufficient. Fleischman and Pons in their original experiment had charged the palladium cathode (i.e. conducted electrolysis) for 7 months and estimated that they had achieved 85% loading of the crystal lattice. (See G. Taubes, “Bad-Science”, Random House, (1993), pp. 1-5.)

Nuclear acoustic resonance occurs when nuclei having non-zero spin (magnetic moment) are placed in a magnetic field; their behavior is characterized by a resonant frequency called the Larmor frequency (see http://hyperphysics.phy-astr.gsu.edu/hbase/nuclear/larmor.html (Larmor frequency) and http://hyperphysics.phy-astr.gsu.edu/hbase/magnetic/larmor.html (Larmor Precession)) which is proportional to magnetic flux density. When this frequency matches the incident ultrasonic frequency, resonance occurs, transitions among spin states are induced, and, if this hypotheses is correct, energy is generated. At least one researcher has achieved resonance at the second harmonic of the Larmor frequency (see B. Strobel et al. Nuclear Acoustic Resonance in Palladium Metal, Letter to the editor, J. Phys. F: Metal Phys., (1979), pp. L247-L250, Vol. 9, No. 12) which raises the possibility that other harmonics might also resonate and perhaps generate energy.

In the nuclear acoustic resonance process, a magnetic field orients the nuclear spins of the hydrogen atoms, and lifts the degeneracy of the spin states, so that when the Larmor (resonant) frequency or its harmonics match an incident ultrasonic frequency, transitions between spin state energy levels are induced. The ultrasonic waves couple to the nuclear magnetic fields by way of dipole and quadrupole electromagnetic fields induced in the metallic lattice. In the present invention, ultrasonic waves are applied to the electrolysis cell via the first and second piezoelectric transducers (18, 22). The application of high frequency acoustic waves (at two different frequencies) causes the bloch quasiparticle deuterons packed within the crystal lattice to transition between spin states of different energy as the alternating magnetic field sweeps the larmor frequency and its harmonics through coincidence (resonance) with the acoustic waves, thereby initiating the conditions for a low energy fusion reaction.

Nuclear acoustic resonance rather than nuclear magnetic resonance is required because acoustic waves will induce spin transitions throughout the bulk of the palladium cathode conductor (12) whereas the electromagnetic waves produced by the nuclear magnetic resonance process only penetrate to a skin depth of about 20 micro-meters@10 Mhz. in copper, for example. (See R. K. Sundfors, et al, Nuclear Acoustic Resonance In Metals And Alloys, a review, Hyperfine Interactions, (1983), pp. 271-313.)

The resonant (Larmor) frequency involved is explained at http://hyperphysics.phy-astr.gsu.edu/hbase/nuclear/larmor.html (Larmor frequency) and http://hyperphysics.phy-astr.gsu.edu/hbase/magnetic/larmor.html (Larmor Precession; however, the formula for frequency calculation does not apply to the deuteron because, having spin=1, its magnetic field has quadrupole components as well as dipole components. (See R. K. Sundfors, et al, Nuclear Acoustic Resonance In Metals And Alloys, a review, Hyperfine Interactions, (1983), pp. 271-313).) The deuteron's larmor frequency (gyromagnetic ratio) is 6.5359 MHz/Tesla. (See Deuterium Nuclear Magnetic Resonance Spectroscopy: 1-Larmor Frequency Ratio, Referencing and Chemical Shift, Jasim M. A. Al-Rawi, George Q. Behnam and Nihad I. Taha, Department of Chemistry, College of Science, University of Mosul, Mosul, Iraq; see also www.ebyte.it/library/educards/constants/ConstantsOfPhysicsAndMath.html.)

Another important principle which the inventor believes is applicable to the low energy fusion process is that of the resonance scan.” The concept of a resonance scan is explained by Dr. Talbot A. Chubb in his book, Cold Fusion Clean Energy for the Future as follows:

“Another important discovery in molecular chemistry and physics has been a recognition that the geometry of a molecule can be made to change to a second geometric structure that has almost the same energy. The condition producing this change is called Feshback resonance. The change occurs during an energy scan process. If one can alter the environment in a manner that changes the energy of one of the configurations differently from the other, one can at some point make the two energies equal. The energy changing process is called a resonance scan. A scan across a resonance can switch the system's internal geometry, leaving the location of the center-of mass unaffected. The physics of molecular quantum mechanics shows that a back and forth scan across a resonance can lead to an energy transfer the hosting environment. As applied to the quasiparticle nuclear states involved in quasiparticle deuteron fusion, the scan process can lead to a transition from a pre-scan paired deuteron state to a pre-scan near resonance metastable initial nuclear state, accompanied by transfer of a small amount of energy and momentum to the hosting metal environment. The metastable nuclear state is a high-energy excited state, many MeV above the helium-4 ground state. However, the transfer of even a small amount of energy to the hosting lattice makes the nuclear reaction irreversible.” (See Talbot A. Chubb, Cold Fusion Clean Energy for the Future, Internet Edition, April 2008, page 63.)

Two of the experimental devices proposed here combine nuclear acoustic resonance (i.e. an alternating magnetic field and two ultrasonic frequencies) with the electrolytic process of the original Fleischman and Pons experiment in order reliably initiate the low energy fusion process and to generate significant latent heat on the order of that originally reported by Fleischman and Pons. The third device described here applies the principles of nuclear acoustic resonance to a reaction chamber containing oxide nano-metal-composite powder and compressed deuterium gas.

The inventor postulates that low energy fusion reactions can be reliably initiated via the nuclear acoustic resonance because of induction of resonance at the harmonics as well as the fundamental Larmor frequency. The inventor further postulates that resonance at the Larmor frequency can be most easily attained by subjecting the electrolytic cell (10) to acoustic waves at two different frequencies, hence the need for the first and second piezoelectric transducers (18, 22) and associated frequency synthesizers (20, 24) of the present invention. The inventor postulates that the specific values of the output frequencies of the piezoelectric transducers can be readily determined by setting the first transducer to 1 MHz and sweeping the second transducer until resonance occurs. Resonance is expected to occur within a frequency range of about 1 to 10 megahertz. The inventor postulates that the actual values of the transducer (18, 22) frequencies may not be of particular importance but only their ratio, (or possibly their difference), due to the alternating magnetic field, which sweeps the Larmor frequency from zero to a maximum and back during each half-cycle.

The foregoing detailed description and appended drawings are intended as a description of the presently preferred embodiment of the invention and are not intended to represent the only forms in which the present invention may be constructed and/or utilized. Those skilled in the art will understand that modifications and alternative embodiments of the present invention which do not depart from the spirit and scope of the foregoing specification and drawings, and of the claims appended below are possible and practical. It is intended that the claims cover all such modifications and alternative embodiments which make use of nuclear acoustic resonance to stimulate low energy nuclear reactions.

1. A low energy fusion reactor for the generation of heat comprising:
an electrolytic cell having a cathode comprised of palladium, an anode comprised of a conductive material and an electrolytic solution comprising heavy water;
a magnetic field generator for applying a magnetic field to the electrolytic cell;
a first acoustic wave generator comprising a first piezoelectric transducer coupled to a first frequency synthesizer and a second acoustic wave generator comprising a second piezoelectric transducer coupled to a second frequency synthesizer, wherein the first and second acoustic wave generators apply first and second acoustic waves to the electrolytic cell, whereby the first and second applied acoustic waves in combination with the applied magnetic field create a nuclear acoustic resonance condition which causes the spin states of the deuterium atoms to interact and thereby induce a cold fusion reaction; and
a direct current power supply for supplying electrical power to the electrolytic cell.

2. The low energy fusion reactor of claim 1 wherein the first acoustic wave generator generates acoustic waves at frequency different from that of the second acoustic wave generator.

3. The low energy fusion reactor of claim 2 wherein the first acoustic wave generator generates a frequency of about one (1) megahertz and the second acoustic wave generator generates a frequency within the range of about 1 to 10 megahertz.

4. The low energy fusion reactor of claim 1 wherein the wherein the magnetic field generator is a solenoid.

5. The low energy fusion reactor of claim 1 wherein the electrolytic solution further comprises at least one metallic conductive salt selected from the group comprising LiOD, Li₂SO₄, D₂SO₄, K₂CO₃.

6. The low energy fusion reactor of claim 1 wherein the anode is comprised of platinum.

7. A cell for the creation of heat energy from hydrogen atoms comprising:
means for loading deuterium atoms within a crystalline lattice;
means for applying a magnetic field to the means for loading deuterium atoms into a crystalline lattice;
means for applying acoustic waves to the means for loading deuterium atoms into a crystalline lattice, whereby the applied acoustic waves in combination with the applied magnetic field create a nuclear acoustic resonance condition which causes the spin states of the deuterium atoms to interact and thereby induce a low energy fusion reaction; and
means for supplying electric power to the deuterium atom loading means.

8. The cell for the creation of heat energy from hydrogen atoms of claim 7, wherein the means for loading deuterium atoms into a crystalline lattice is an electrolysis cell comprising a reaction vessel, a cathode comprising a crystalline lattice capable of absorbing deuterium atoms, an anode of conductive material, and an electrolytic solution containing deuterium atoms.

9. The cell for the creation of heat energy from hydrogen atoms of claim 8, wherein the cathode comprises palladium.

10. The cell for the creation of heat energy from hydrogen atoms of claim 8, wherein the anode comprises platinum.

11. The cell for the creation of heat energy from hydrogen atoms of claim 8, wherein the electrolytic solution comprises deuterium and an electrolytic salt selected from the group comprising LiOD, Li₂SO₄, D₂SO₄, K₂CO₃.

12. The cell for the creation of heat energy from hydrogen atoms of claim 7, wherein the means for applying acoustic waves includes at least one piezoelectric transducer coupled to at least one frequency synthesizer.

13. The cell for the creation of heat energy from hydrogen atoms of claim 7, wherein the means for applying acoustic waves comprises first and second piezoelectric transducers coupled to first and second frequency synthesizers, respectively.

14. The cell for the creation of heat energy from hydrogen atoms of claim 9, wherein the first piezoelectric transducer generates acoustic waves at a frequency different from that of the second piezoelectric transducer.

15. The cell for the creation of heat energy from hydrogen atoms of claim 7, wherein the means for means for applying a magnetic field to the means for loading deuterium atoms into a crystalline lattice is a solenoid.

16. A cell for the creation of heat energy from hydrogen atoms comprising:
an electrolytic cell having a cathode comprised of palladium, an anode comprised of a conductive material and an electrolyte comprising heavy water;
a magnetic field generator for applying a magnetic field to the electrolytic cell;
a first acoustic wave generator and a second acoustic wave generator for applying first and second acoustic waves to the electrolytic cell, whereby the first and second applied acoustic waves in combination with the applied magnetic field create a nuclear acoustic resonance condition which causes the spin states of the deuterium atoms to interact and thereby induce a cold fusion reaction; and
a direct current power supply for supplying electrical power to the electrolytic cell.

17. The cell for the creation of heat energy from hydrogen atoms of claim 16, wherein the electrolyte further comprises at least one conductive salt selected from the group comprising LiOD, Li₂SO₄, D₂SO₄, K₂CO₃.

18. The cell for the creation of heat energy from hydrogen atoms of claim 16, wherein the first and second acoustic wave generators comprise first and second piezoelectric transducers coupled to first and second frequency synthesizers.

19. The cell for the creation of heat energy from hydrogen atoms of claim 16, wherein the first acoustic wave generator generates acoustic waves at a frequency different from that of the second acoustic wave generator.

20. The cell for the creation of heat energy from hydrogen atoms of claim 16, wherein the magnetic field generator is a solenoid.

21. A low energy fusion heater comprising:
an electrolytic cell comprising a solid electrolyte have two opposing sides, a cathode comprising a metallic foil capable of absorbing hydrogen atoms affixed to one side of the solid electrolyte, and an anode comprising a metallic foil affixed to the other side of the solid electrolyte;
a means for applying and surrounding the solid electrolytic cell with deuterium gas;
a means of applying an electric potential across the cathode and anode of the solid electrolytic cell;
a magnetic field generator for applying a variable alternating magnetic field to the electrolytic cell; and
a first acoustic wave generator comprising a first piezoelectric transducer coupled to a first frequency synthesizer and a second acoustic wave generator comprising a second piezoelectric transducer coupled to a second frequency synthesizer, wherein the first and second acoustic wave generators apply first and second acoustic waves to the electrolytic cell, whereby the first and second applied acoustic waves in combination with the applied magnetic field create a nuclear acoustic resonance condition which causes the spin states of the deuterium atoms to interact and thereby induce a cold fusion reaction.

22. The low energy fusion heater of claim 21 wherein the first acoustic wave generator generates acoustic waves at frequency different from that of the second acoustic wave generator.

23. The low energy fusion heater of claim 22 wherein the first acoustic wave generator generates a frequency of about one (1) megahertz and the second acoustic wave generator generates a frequency within the range about one (1) megahertz to about 10 megahertz.

24. The low energy fusion heater of claim 21 wherein the wherein the magnetic field generator is a solenoid.

25. A low energy fusion reactor comprising:
a reaction chamber containing oxide-nano-metal composite powder pressurized with deuterium gas;
a magnetic field generator for applying an alternating magnetic field to the reaction chamber; and
first and second acoustic wave generators for generating high frequency acoustic waves at a first frequency and a second frequency, wherein the application of high frequency acoustic waves causes the bloch quasiparticle deuterons adsorbed on the oxide-nano-metal composite powder surface to transition between spin states of different energy as the alternating magnetic field sweeps the larmor frequency and its harmonics through coincidence with the acoustic waves, thereby initiating the conditions a low energy fusion reaction.

26. The low energy fusion reactor of claim 25, wherein the first and second acoustic wave generators comprise first and second piezoelectric transducers coupled to first and second frequency synthesizers.

27. The low energy fusion reactor of claim 25, wherein the first acoustic wave generator generates acoustic waves at a frequency different from that of the second acoustic wave generator.

28. The low energy fusion reactor of claim 25, wherein the magnetic field generator is a solenoid.
